(19) United States
(12) Patent Application Publication
(10) Pub. No.: US 2009/0150370 A1
(43) Pub. Date: Jun. 11, 2009

(54) System and Method For Restricted Party Screening and Resolution Services

(75) Inventors: Larry Christensen, Madison, VA (US); James K. Wilson, Mead, CO (US); Warren M. Linscott, JR., Ashburn, VA (US); Amish Sheth, Ashburn, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: JPMorgan Chase Bank, N.A., New York, NY (US)

(21) Appl. No.: 11/744,471

(22) Filed: May 4, 2007

Related U.S. Application Data
(60) Provisional application No. 60/746,467, filed on May 4, 2006.

(51) Int. Cl. G06F 17/30

(52) U.S. Cl. 707/5; 707/E17.108

(57) ABSTRACT

A system and method for screening data for restricted party screening. The system comprises an input for entering data, a screening system for screening the data against a database comprising restricted entities information, generating a match score based on the screening of the data, providing a data match based on the match score, and outputting the data match, a work queue for reviewing the data match, and a report generated based on the review of the data match.

### CROSS-REFERENCE TO RELATED APPLICATIONS

This application claims priority to Provisional Application Ser. No. 60/746,467, filed May 4, 2006, titled “System and Method for Restricted Party Screening and Resolution Services,” Attorney Docket No. 47004.000425, which is incorporated herein by reference in its entirety.

### FIELD OF THE INVENTION

The present invention relates generally to a data processing system and method for restricted party screening, and more particularly, to a system and method that provides a solution for companies to protect their trade interests by providing services to help prevent illegal domestic and international transactions.

### BACKGROUND OF THE INVENTION

Governments around the world have published various entity lists which identify individuals, companies, and countries subject to government restrictions. These restrictions vary enormously—from an entity with which it is expressly forbidden to have any contact, to an entity that is restricted in trading certain goods, to an entity that might require an export license from the appropriate government. In response to a rise in global terrorism and concerns of weapons proliferation, governments have placed even more trade restrictions on an increasing number of individuals and companies.

In addition to entity controls, there are also trade sanctions and embargoes against entire countries. As a result, it has become increasingly difficult to perform complex international business while ensuring that the customer's prospects, suppliers, and distributors are not subject to restrictions at the entity and country levels.

Commercial entities are often left on their own to verify a match with a certain restricted parties list, which may not even be the most updated one. Because there often is no central list of denied parties, companies face the challenging issue of how to screen against an overwhelming volume of information without impacting productivity. Basic automation may be used to provide some assistance. But existing basic resolution services lack an automated system and database/query process for restrictive party screening. In addition, most conventional screening products provide very limited functionality. For example, a user would be required to manually enter individual entities without the ability to load batches of entities, generate reports, or maintain an audit trail. Moreover, conventional screening products tend to have high implementation costs and are not generally offered in a stand-alone configuration. As a result, conventional screening systems and processes may often become expensive, inefficient, inaccurate, and unreliable.

Other problems and drawbacks may also be considered.

### SUMMARY OF THE INVENTION

A system and method for screening data for restricted party screening. The system comprises an input for entering data, a screening system for screening the data against a database comprising restricted entities information, generating a match score based on the screening of the data, providing a data match based on the match score, and outputting the data match, a work queue for reviewing the data match, and a report generated based on the review of the data match. The system and method further comprise a component for tokenization, a component for word token comparisons, and component for phrase match comparisons. The components for tokenization, for word token comparisons, and for phrase match comparisons further comprise a tuning configuration. The system and method further comprise a match verification component for reviewing the report and generating a match verification decision. The match verification may be provided by either a user or a host agent.

The benefits and advantages of the present invention may include providing a system and method for consolidating domestic and international restricted lists, providing real-time risk screening technology based on distinct tunable screening algorithms and various dictionaries, daily monitoring and updates, complying with audit trail and management reporting standards, providing a host agent response team for match verification, and providing a low cost solution with excellent usability, workflow, and minimal implementation costs.

According to one aspect of the present invention, in order to overcome one or more of the aforementioned and other limitations of existing systems and methods, a restricted party screening and resolution services may be provided.

In accordance with another aspect of the present invention, a software system and method for providing heuristic screening that incorporates a screening engine utilizing distinct and tunable algorithms, a variety of dictionaries, and storage capabilities to ensure a low-cost and reliable solution for screening may also be provided.

In accordance with another aspect of the present invention, a system and method for providing a match verification services team with knowledge, experience, and expertise in managing and resolving potential matches to increase workflow and productivity may further be provided.

In accordance with another aspect of the present invention, a system and method for consolidating domestic and international restricted lists and providing real-time risk screening technology may additionally be provided.

In accordance with another aspect of the present invention, a system and method for daily monitoring and updates, audit trail compliance, and management reporting may also be provided.

Additional features and advantages of the invention will be set forth in the description that follows, and in part will be apparent from the description, or may be learned by practice of the invention. The aspects and other advantages of the invention will be realized and attained by the system and methods, particularly pointed out in the written description and claims hereof as well as the appended drawings.

### BRIEF DESCRIPTION OF THE DRAWINGS

FIG. 1 depicts an illustrative system for restrictive party screening according to one embodiment of the present invention.

FIG. 2 depicts an illustrative process for screening restrictive party data according to one embodiment of the present invention.

FIG. 3 depicts the overall system architecture according to an embodiment of the present invention.

FIG. 4 depicts a manual entry screenshot according to an embodiment of the present invention.

FIG. 5 depicts an exemplary screenshot of screening results according to an embodiment of the present invention.

FIG. 6 depicts a system for screening data according to another embodiment of the present invention.

FIG. 7 depicts data processing logic for a screening engine system according to an embodiment of the present invention.

FIG. 8 depicts a list configuration screenshot according to an embodiment of the present invention.

FIG. 9 depicts a reports menu screenshot according to an embodiment of the present invention.

### DETAILED DESCRIPTION

Exemplary embodiments of the invention are discussed in detail below. While specific exemplary embodiments are discussed, it should be understood that this is done for illustration purposes only. A person skilled in the relevant art will recognize that other components and configurations may be used without departing from the spirit and scope of the invention.

### Overview and System Architecture

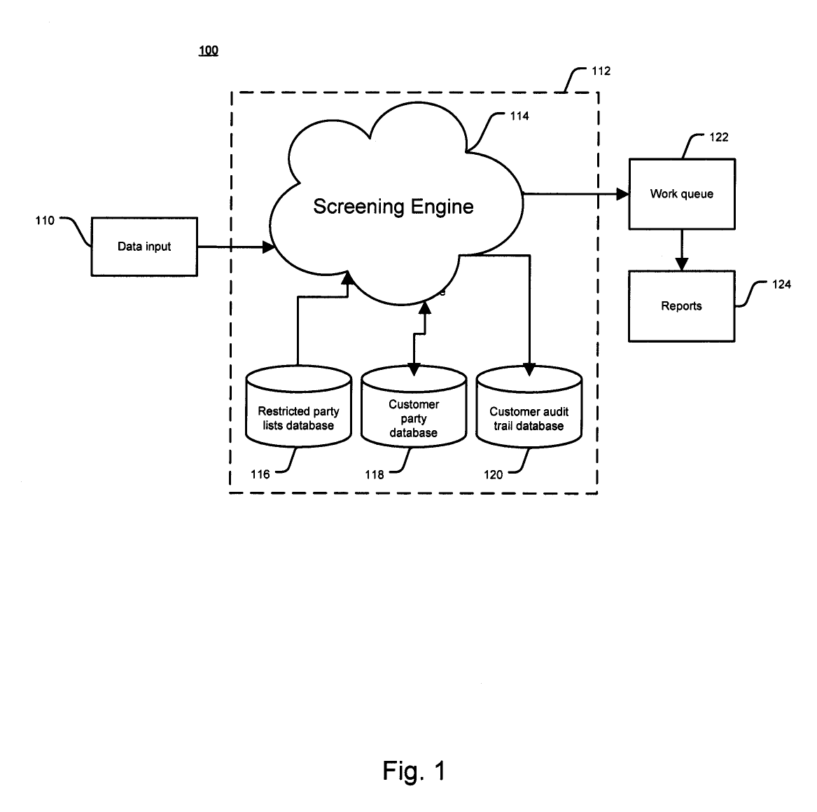

FIG. 1 is an illustrative system according to one embodiment of the present invention. As illustrated in FIG. 1, system 100 may comprise an input 110 for entering data, a screening engine system 112 for generating data matches, a work queue 122 for reviewing data matches, and a report 124, which may be generated based on the review of data matches. Data may be inputted via the input 110 in a in a variety of ways, such as manual entry, text flat-file loading, or XML messaging. Once the data is entered through the input, it may be transmitted to the automated screening engine system 112.

The screening engine system 112 may comprise a screening engine 114 and several databases. These databases may include a restricted party lists database 116, a customer party database 118, and a customer audit trail database 120. When the automated screening engine 114 receives the data from the input 110, it may be screened against one or more databases to generate a data match. The data match may then be outputted to a work queue 122 for review. During the review, potential matches may be resolved by the user or the host. In one embodiment, the user may review the work queue 122 by any form of an internal review protocol, e.g., in a hosted solution application. In another embodiment, a host may provide resolution services to the user to resolve potential matches produced from the screening using an ISO compliant protocol on the user's behalf. Once potential data matches are reviewed, reports based on the review may be generated. While one configuration is shown in FIG. 1, it should be appreciated by one of ordinary skill in the art that other configurations of these various modules may also be possible.

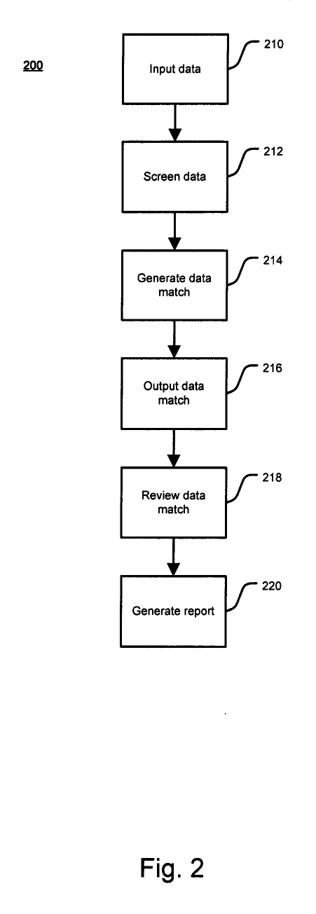

FIG. 2 is an illustrative method according to one embodiment of the present invention. Here, method 200 may comprise inputting data 210, screening data 212, generating a data match 214, outputting the data match 216 for review 218, and generating a report 220. While one configuration is shown in FIG. 2, it should be appreciated by one of ordinary skill in the art that other configurations of these various modules may also be possible.

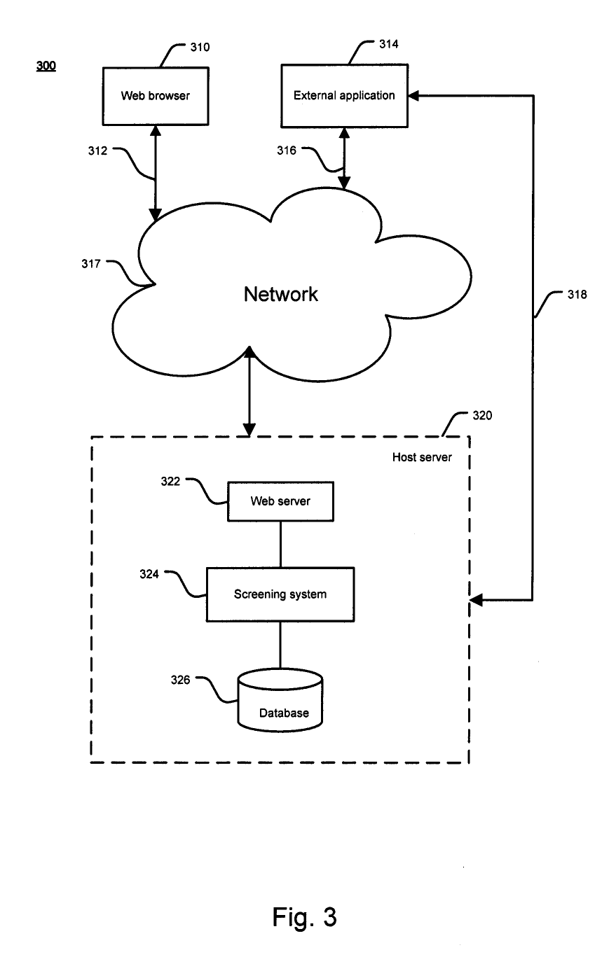

FIG. 3 is an overall system architecture for one embodiment of the present invention. In this embodiment, the user may have access to all necessary application functionality to perform potential match resolution, configure the lists which they screen against, and generate reports for internal use. As illustrated, FIG. 3 may comprise a web browser 310, e.g., Internet Explorer, Netscape, or Firefox, to connect 312 to the host server 320 via the network through HTTP/HTTPS. An external application 314 may also connect 316 to the host server 320 via the network 317 through HTTP/HTTPS. Such a connection may be useful for the transmission of XML messages. The HTTP/HTTPS may also utilize encryption to prevent unauthorized access to data. The external application 314 may also connect 318 to the host server through a secure FTP transaction. This may be useful for transmitting delimited data, such as ASCII text flat-files. The host server 320 may comprise a web server 322, a screening system 324, and at least one database 326. In one embodiment, the web server 322 may comprise an IBM HTTPS web server. In another embodiment, the screening system 324 may comprise a JSP servlet for processing code and a Java-based screening engine. Other processing options may include the use of a computer, a laptop, a workstation, a PDA, a mobile phone, an RFID, a smart chip and/or other wireless/mobile devices. In another embodiment, the databases may utilize Oracle 8i. Various embodiments of database types and configurations may also be contemplated. In one embodiment, the network may comprise the Internet, intranet, wireless network, or another form of web access, such as LAN, WAN, PAN, etc. However, other networks may also be utilized to connect each of the various systems, components, and/or servers. While one configuration is shown in FIG. 3, it should be appreciated by one of ordinary skill in the art that other configurations of these various modules may also be possible. Accordingly, other web servers, screening engines, and database models may be utilized and considered.

### Hosted Solution

In one embodiment of the present invention, a hosted solution application option may be available to users. Here, the hosted solution may be in the form of a software application that is customized to a user's needs based on transactional volume and other business requirements. While one configuration is described, it should be appreciated by one of ordinary skill in the art that other configurations, such as any type of computer-storage media or web-hosted application, may also be possible. A user may be given a user account for access to areas of the application that may be specific to each of the various user's roles. According to one embodiment, a user may only have access to the manual screening portion of the application. Here, the user may not be authorized to make screening decisions. In another embodiment, one type of user may have access to the manual screening window, the work queue, and the reports. Here, the user may be authorized to make screening decisions and generate reports. In another embodiment, a user may have access to all of the areas of the screening system described above. Here, the user may have additional authorization to a configuration page which allows the user to control which restricted party lists will be used when screening occurs. In yet another embodiment, administrator privileges may be considered for other customizable features as well. The combination of the aforementioned embodiments may provide users with the flexibility to customize and tailor the hosted solution application for their screening needs. While each of these embodiments may provide different levels of user access, it may be possible for users with various access authorization to exist within one embodiment if desired.

An advantage of the hosted solution is that the application work queue allows users to quickly review and make decisions on potential data matches generated through batch or real-time processing. Another advantage is that the user may have a wide array of standard reports that can be used fulfill internal processes and audit requirements.

### Operational Solution

Another embodiment of the present invention may comprise a system and method comprising an operational approach to restricted party screening via a backend software tool. According to one embodiment of the invention, the user may provide data for automated screening by manual entry or text flat-file loading. Once the data has been received and screened using the automated screening engine, a host agent may resolve potential matches produced from the initial screening using and ISO compliant process on the user's behalf. After an initial resolution services has been provided by the host, reports which detail the work that has been performed and highlighted entities requiring further review may be made available to the user for compliance due diligence. Although the user may have limited access in this embodiment to the run reports, manage the screening configuration, or make decisions on potential matches, a user may be allowed to have interaction via manual entry of partner data through a web user interface. Alternative integration methods and data storage and maintenance may also be provided to the user in another embodiment.

One advantage of the operational solution is that it eliminates a user's need to have trained in house personnel to resolve and review potential data matches. An operational approach provides a highly skilled and dedicated team with the trade expertise to resolve a match that would otherwise be timely and costly.

### Inputting Partner Data

As described above, users may enter data for screening in three ways: (1) manual screening, (2) text flat-file integration, or (3) XML integration. Restrictions may be placed on the transport protocol for each of the integration types in addition to security restrictions. Alternative integration methods may be provided to the user upon request, which may entail a separate dedicated environment or installation of additional applications on the user's site.

### Manual Entry

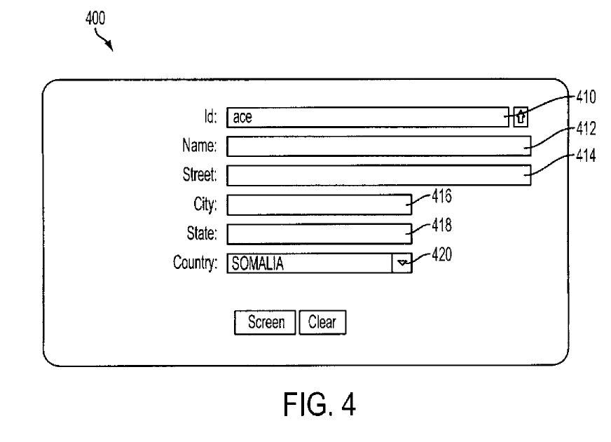

In one embodiment, manual entry may be accomplished by the user by entering the name and address data into system for screening. In addition to the name and address fields, a user may also enter a unique identification (ID) number for a predetermined partner. FIG. 4 is an illustrative a screenshot for manual entry of partner input data according to one embodiment of the invention. Table 1 is an exemplary table that provides a description of each of the manual entry fields depicted in FIG. 4.

TABLE 1
Manual Entry Field Description

| Field | Description |
|---|---|
| ID | 410. Unique partner identification number created |
| | by user or generated by host system. |
| Name | 412. Full, shortened, or abbreviated name of individual, |
| | commercial entity, or other naming conventions. |
| Street | 414. Street, suite, apartment number, districts, or other |
| | components of address not normally covered under City, |
| | State, or Country. |
| City | 416. City, town, village, or other postal destinations. |
| State | 418. Name of state, province, county, or other |
| | geographical boundary designations. |
| Country | 420. Country in which partner resides or is based from. |

As described above, users having the appropriate security role or access authorization may review and decide on potential data matches. Users who do not have the appropriate security role may receive a response as to whether the screening engine system has identified a “potential match” or whether “no match” was found.

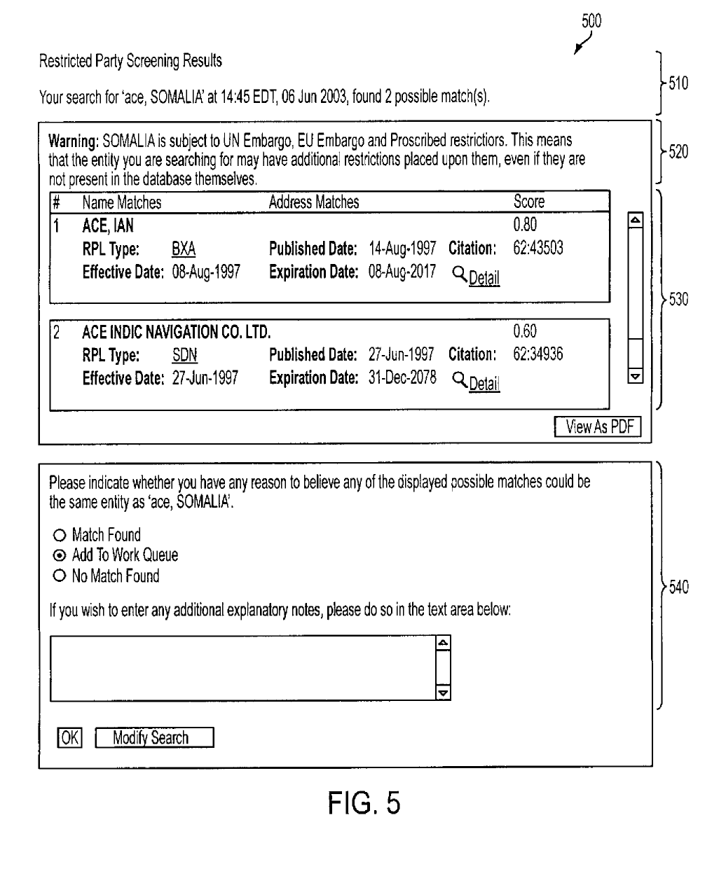

FIG. 5 is an illustrative screenshot of a sample screening results page 500. The screenshot may be the generated in response to data entered as described above. The header 510 may display the partner name and address that a user entered for screening. It also indicates the number of matches. Here, the entered search fields are “ace” for NAME and “Somalia” for the COUNTRY and the results page header 510 indicates that there are two possible matches. Body header 520 may display country screening results. Here, the body header 520 indicates that Somalia is subject to UN Embargo, EU Embargo, and Proscribed restrictions. Body 530 may display the actual entity match. In this case, there are two possible matches and a “Detail” link may be available for more information explaining the possible match. The “RPL Type” link may provide more information regarding the list that contains the entity. Decision block 540 may provide an interface for an authorized user to select a decision based on the screening results. Here, the options are “Match found,” “Add to work queue,” and “No match found.” Decision block 540 may also provide other a text box for entering a user's notes and/or comments regarding the screening. Various alternatives and interface options may also be considered.

### Flat File Input

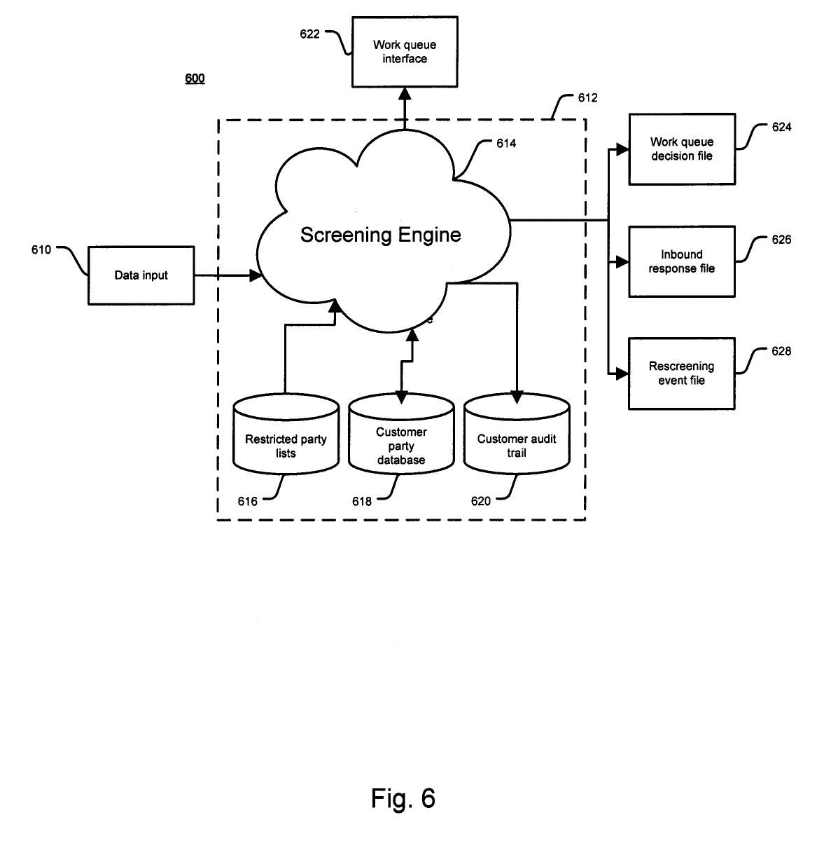

FIG. 6 depicts a screening system 600 having a data input 610 for flat-file integration or XML messaging. Because system 600 of FIG. 6 flows out of system 100 of FIG. 1, FIG. 6 should be understood in relation to FIG. 1 and the elements as described in relation to FIG. 1 should apply to FIG. 2 as well.

In one embodiment of the present invention, flat file integration may be performed using the host's Secure FTP server. Here, using a secure FTP server having, for example, Open SSH 2.0 encryption, a user may transmit input data 610 in text flat files to the host screening engine system 612. Other secure FTP servers may comprise Putty, F-secure, and other formats to support SSH protocol. The flat-file format may be useful for loading multiple partner data into the hosted solution software. In one embodiment, multiple partner information may be loaded even within a single file. However, a user may also load single partner data as well, if desired. The file format may be defined to enable the host to process the data and return the match information to the user through a text file.

In a delimited file format as discussed above, there may be pre-defined, pipe-separated (|) text formatting. These may comprise:
Pipe-separated (|) text. The logical- or vertical-bar pipe is the ASCII character coded by: DEC 124, OCT 174, HEX 7C, and BINARY 01111100;
Enclosed text that may contain pipes in double quotes;
Text containing a double quote to be preceded by a double quote and the entire text to be enclosed in double quotes;
Each record to exist on a separate line;
All fields to be included even if blank.

Accordingly, a flat-file request input data format may appear as follows:

PTNR|PARTNER_ID|PARTNER_TYPE|SUB_ORG||APP_ID|NAME|ADD1|ADD2|AD
D3|ADD4|ADD5|CITY|STATE|STATE_CODE|POSTAL|CTRY_CODE|USER|URL|U
SE_CACHE|PERSIST|USERVARCHAR1|USERVARCHAR2|USERVARCHAR3

One example of this format according to one embodiment of the invention may appear as follows:

PTNER|00194JFR|SHIP_TO|COMPANY_SUBORG|TPRPL_100|PARTNER
NAME|1234 Main Street||||||Fairfax|VA|20132|US|BOBM
http://client/server.com/receipt.cgi|TRUE|TRUE|021332022|
22|MASTER_RECORD

Table 2 is an exemplary table that provides a description of each of the flat-file entry fields depicted above.

TABLE 2
Flat-File Request Format Description

| Field | Name | Description | Required |
|---|---|---|---|
| PTNR | Partner | A fixed-value file designation attribute, | Yes |
| | | which the system uses to recognize the | |
| | | inbound file. | |
| PARTNER_ID | Partner ID | Unique partner identifier that the system | Yes |
| | | uses in the response message and for | |
| | | auditing. | |
| PARTNER_TYPE | Partner type | Identifies the type of partner since partner | Yes |
| | | type not typically recognized during | |
| | | screening. | |
| SUB_ORG | Suborg | System identifier for the client that may be | Yes |
| | | provided during rapid implementation | |
| | | phase. | |
| APP_ID | Application | Identifies the instance of the screening | Yes |
| | ID | engine, which may be provided during the | |
| | | rapid implementation phase. | |
| NAME | Name | The individual/contact name and/or | Yes |
| | | company or entity name of the partner. | |
| | | The system may recognize a single name | |
| | | input string. | |
| ADD1 | Address 1 | Address line 1 | No |
| ADD2 | Address 2 | Address line 2 | No |
| ADD3 | Address 3 | Address line 3 | No |
| ADD4 | Address 4 | Address line 4 | No |
| ADD5 | Address 5 | Address line 5 | No |
| CITY | City | Postal town, city, or district of the partner. | No |
| STATE | State name | State, county, or province of the partner. | No |
| STATE_CODE | ISO state | Two-letter ISO state code, if known. | No |
| | code | | |
| POSTAL | Postal code | Postal code of partner. | No |
| CTRY_CODE | ISO country | Two-letter ISO country code of partner, if | No |
| | code | known. | |
| USER | Client user | Not typically used by screening system, | No |
| | data | but may be used as the User ID who | |
| | | originally created the partner. | |
| URL | Request | The HTTP address to which the screening | No |
| | URL | system sends response XML messages. | |
| USE_CACHE | Use cache | A Boolean field with values of TRUE or | Yes |
| | result | FALSE: | |
| | | TRUE instructs the system to locate | |
| | | a partner with the same partner ID. | |
| | | If the system finds a matching | |
| | | partner, the system uses the | |
| | | matching decision stored against | |
| | | that partner. Selecting TRUE | |
| | | prevents repetitive false-positive | |
| | | hits against the same partner. | |
| | | FALSE overwrites the previous | |
| | | screening results of the partner | |
| | | with the same partner ID with the | |
| | | new results. | |
| PERSIST | Persist | A Boolean field with values of TRUE or | Yes |
| | | FALSE: | |
| | | TRUE instructs the system to | |
| | | maintain the partner in the database | |
| | | for future use such as rescreening, | |
| | | reports, or the audit trail, for | |
| | | example. | |
| | | FALSE does not retain any partner | |
| | | details in the database. | |
| USERVARCHAR1 | User field 1 | For use by user. Examples may include | No |
| | | Order ID, Date, Note, or other identifier. | |
| USERVARCHAR2 | User field 2 | For use by user. Examples may include | No |
| | | Order ID, Date, Note, or other identifier. | |
| USERVARCHAR3 | User field 3 | For use by user. Examples may include | No |
| | | Order ID, Date, Note, or other identifier. | |

According to an embodiment of the present invention, the output data file format may be defined to enable a user or a user's system to process the results and perform the necessary updates on its own system. Response files may be generated as a word queue decision file 624, inbound response file 626, or a rescreening event file 628. A word queue decision file 624 may be a single file generated by the system when the user selects a decision during the review stage from the word queue. This file 624 may be sent using secure FTP to the user and may contain the result for a single partner. The inbound response file 626 may process all partner data and may identify each partner as a possible match or not a match. The result of the inbound response file 626 may correspond to the partner input files. For example, if the input data contained one hundred partners, the response file 626 may contain the screening decisions for the same one hundred partners. The rescreening event file 628 may send a file to the user's application it finds a possible match between a new or amended entity and an existing partner. The rescreening event file 628 may contain the matching details for one partner. If partners possibly match one or more entities, the screening engine system 612 may output multiple files.

A sample flat-file response according to one embodiment of the invention may appear in the following format:

PTNR Record
EMS_RPL Record (0 or more, per PTNR record)

RPL_NAM Record (0 or more, per EMS_RPL record)
RPL_ADD Record (0 or more, per EMS_RPL record)
RPL_CIT Record (0 or more, per EMS_RPL record)

Here, the PTNR Record may appear as follows:

PTNR|PARTNER_ID|PARTNER_TYPE|SUB_ORG||APP_ID|NAME|ADD1|ADD2|AD
D3|ADD4|ADD5|CITY|STATE|STATE_CODE|POSTAL|CTRY_CODE|USER|URL|U
SE_CACHE|PERSIST|USERVARCHAR1|USERVARCHAR2|USERVARCHAR3|DECISI
ON|RPL_INDICATOR|EPCI_INDICATOR|ANTIBOYCOTT_INDICATOR|USEMBARG
O_INDICATOR|UNEMBARO_INDICATOR|EUEMBARO_INDICATOR|PROSCRIBED
_INDICATOR

The entity details may appear as follows:

EMS_RPL|MATCH_STRENGTH|SUB_ORG|RPL_ID|CTRY_CODE|RPL_TYPE|ENTIT
Y_TYPE
RPL_NAM|MATCH_STRENGTH|SEQ_NUM|NAME
RPL_ADD|MATCH_STRENGTH|SEQ_NUM|ADDRESS_1|ADDRESS_2|ADDRESS_3|A
DDRESS_4|ADDRESS_5|CITY|STATE_CODE|STATE_NAME|CTRY_CODE|CTRY_N
AME|POSTAL_CODE|PHONE|FAX|EMAIL
RPL_CIT|MATCH_STRENGTH|SEQ_NUM|GOV_DOC_VOL|GOV_DOC_PAGE|GOV D
OC_DATE|EFFECTIVE_DATE|EXPIRATION_DATE

The entity detail elements in the response message may be included if the Administrator selects the option during configuration. If selected, the system may include one entity detail element for each matching RPL record. For any given response, there may be zero or more EMS_RPL, RPL_NAM, RPL_ADD, or RPL_CIT records. If the entity detail information is not selected, the system may not return any such records.

Table 3 is an exemplary table that provides a description of each of the flat-file response fields depicted above according to one embodiment of the present invention, in addition to those shown in Table 2.

TABLE 3
Flat-File Response Format Description

| Field | Name | Description |
|---|---|---|
| DECISION | User decision | Set by the user. A value of N indicates |
| | | “no match” and Y indicates “match.” |
| RPL_INDICATOR | Entity result | A value of N indicates “no match” and C |
| | | indicates “possible match.” |
| EPCI_INDICATOR | EPCI result | A value of N indicates “no match” and Y |
| | | indicates “possible match.” |
| ANTIBOYCOTT_INDICATOR | Anti-boycott | A value of N indicates “no match” and Y |
| | result | indicates “possible match.” |
| USEMBARGO_INDICATOR | US embargo | A value of N indicates “no match” and Y |
| | result | indicates “possible match.” |
| UNEMBARGO_INDICATOR | UN embargo | A value of N indicates “no match” and Y |
| | results | indicates “possible match.” |
| EUEMBARGO_INDICATOR | EU embargo | A value of N indicates “no match” and Y |
| | results | indicates “possible match.” |
| PROSCRIBED_INDICATOR | US proscribed | A value of N indicates “no match” and Y |
| | results | indicates “possible match.” |
| ADDRESS_1 | Address 1 | Address line 1 |
| ADDRESS_2 | Address 2 | Address line 2 |
| ADDRESS_3 | Address 3 | Address line 3 |
| ADDRESS_4 | Address 4 | Address line 4 |
| ADDRESS_5 | Address 5 | Address line 5 |
| EFFECTIVE_DATE | Effective | Date the entity legislation came into |
| | date | effect. |
| EMAIL | Email | Known e-mail address of the restricted |
| | | entity. |
| EMS_RPL | Entity header | Identifies various parameters for a |
| | | matching entity. |
| ENTITY_TYPE | Entity type | Reserved for future use. |
| EXPIRATION_DATE | Expiration | Date the entity legislation expires. |
| | date | |
| FAX | fax | Known fax number of the restricted |
| | | entity. |
| GOV_DOC_DATE | Citation date | Date of publication for the entity |
| | | legislation. |
| GOV_DOC_PAGE | Citation page | The page number of the entity |
| | number | legislation. |
| GOV_DOC_VOL | Citation volume | The volume of the entity legislation. |
| | number | |
| MATCH_STRENGTH | Match | The system-calculated match probability |
| | strength | between the partner and the entity. |
| RPL_ADD | Entity | Header that identifies various address |
| | address | parameters for a matching entity. |
| RPL_CIT | Entity | Header that identifies various citation |
| | citation | parameters for a matching entity. |
| RPL_CTRY_CODE | Restricted | Represents the country, dependency, or |
| | country code | area of special sovereignty where the |
| | | restricted entity originated. This may |
| | | differ by CTRY_CODE, which reflects a |
| | | country for a specific address. |
| RPL_ID | Entity ID | ID from the RPL database of the |
| | | matching entity. |
| RPL_NAM | Entity name | Header to identify various name |
| | | parameters for a matching entity. |
| RPL_TYPE | Restricted | Identifies the published list that contains |
| | list name | the entity. |
| SEQ_NUM | Sequence | Identifies each unique record identifier |
| | number | within each XML header tag. |

There are several events that may cause the screening system to send response data to the user: (1) Synchronous response to a partner load, (2) Asynchronous response from the work queue, and (3) Asynchronous message following and RPL update.

For synchronous response to a partner load, the user may send in one or mare partner data to the screening engine via flat file. In response, the screening engine may send a decision response message. The decision fields are RPL_IND and DECISION. Two different scenarios may include: (a) No match during screening: DECISION equals N, RPL_IND equals N; or (b) Match during screening: DECISION equals C, RPL_IND equals C.

For asynchronous response from the work queue, the user may set a decision from the work queue. In response, the screening engine may return an asynchronous message to the user containing the data for that single partner. The decision fields are RPL_IND and DECISION. Two different scenarios may include: (a) No match during work queue: DECISION equals N, RPL_IND equals C; or (b) Match during work queue resolution: DECISION equals Y, RPL_IND equals C.

Asynchronous message following an RPL update may include a adding a new entity or amending an existing entity to the database. Here, the application may rescreen those changes against the partners held in the database. If any of the partners provide a match, irrespective of any decisions that have gone before, an asynchronous message may be sent to the use containing the details for that single partner. At that point, the user may provide a decision as to what to do with this result. The user may place the transaction on hold relating to this partner or wait for the decision from the work queue. Various alternatives and embodiments may also be considered.

In addition to the elements such as Name and Address, there may also be certain operators set by the Administrator that control the system's response to the requestor file. These may include the option of storing the partner data in the database (in the case of one-off batch screening), the option to use previous screening results for a partner, and to specify the response message destination if an XML response is required.

### XML Input

In another embodiment of the present invention, XML messages may be sent to the application embedded as the body of an HTTPS request. Here, the format of the XML may be defined to enable the host to process the partner data and return the screening information in an XML message to the user. Input XML messages 610 may contain information specific to each partner data.

In one embodiment of the present invention, a sample XML request format for a single partner may be entered as follows:

<RPSL_PTNR

ptnr_id = “PTNR1”
ptnr_type = “SHIP_TO_PARTNER”
sub_org = “100”
app_id = “TPRL_100”
name_1 = “NAME”
address_1 = “ADD1”
address_2 = “ADD2”
address_3 = “ADD3”
address_4 = “ADD4”
address_5 = “ADD5”
city = “CITY”
state_name = “STATE”
state_code = “STATE_CODE”
postal_code = “POSTAL”
ctry_name = “CTRY”
ctry_code = “CTRY_CODE”
created_by = “USER”
request_url = “http://myurl”
use_cache_result = “FALSE”
persist = “TRUE”
user_varchar1 = “TRANSACTION_ID”
user_varchar2 = “GEOGRAPHICAL_LOCATION”
user_varchar3 = “TIME_SUBMITTED”

/>

Multiple partner data may also be submitted to the screening engine system 612 in a single XML message by “wrapping” each partner in an XML tag. In another embodiment, a sample XML request format for a multiple partners may be entered as follows:

<RPSL_BATCH>

<RPSL_PTNR ... />
...
<RPSL_PTNR ... />

</RPSL_BATCH>

Output data file format may be defined to enable a user or a user's system to process the results and perform the necessary updates on its own system. Response files may be generated as a work queue decision file 624, inbound response file 626, or a rescreening event file 628. In another embodiment, a sample XML response format for a multiple partners may be entered as follows:

<RPSL_PTNR

ptnr_id = “PTNR1”
ptnr_type = “SHIP_TO_PARTNER”
sub_org = “100”
app_id = “TPRL_100”
name_1 = “NAME”
address_1 = “ADD1”
address_2 = “ADD2”
address_3 = “ADD3”
address_4 = “ADD4”
address_5 = “ADD5”
city = “CITY”
state_name = “STATE”
state_code = “STATE_CODE”
postal_code = “POSTAL”
ctry_name = “CTRY”
ctry_code = “CTRY_CODE”
decision = “Y”
rpl_ind = “C”
epci_in = “Y”
antiboycott_ind = “Y”
usembaro_ind = “Y”
unembargo_ind = “Y”
euembargo_ind = “Y”
proscribed_ind = “Y”
user_varchar1 = “TRANSACTION_ID”
user_varchar2 = “GEOGRAPHICAL_LOCATION”
user_varchar3 = “TIME_SUBMITTED”

/>

Each of the XML message fields depicted above are analogous to the flat-file fields discussed in Tables 1-3 above. Various alternative coding formats and fields may also be considered.

In another embodiment, there may be several events that cause the screening system to send response data to the user. These data transmission events are analogous to the events discussed above for flat-files.

### Screening

As described above, and now in further detail, significant features of the present invention may include: (1) advanced screening technology and management control, (2) list consolidation and management, (3) enhanced reporting tools, and (4) resolution services.

The advanced screening technology may comprise an extensive screening protocol that covers information to identify restrictions as published by domestic and international government agencies and organizations. As discussed above, several distinct screening elements may exist. These may include names (people, companies, organizations, etc.), addresses, and countries. In addition, users may manually enter these distinct screening elements into the hosted or operational solution system. Users may also input the information by a batch-loading option as well for increased efficiency. An immediate automated response or may be available for the user, where the user may be made aware of validity of possible matches at several levels (valid match, indeterminate, false positive, or no-match).

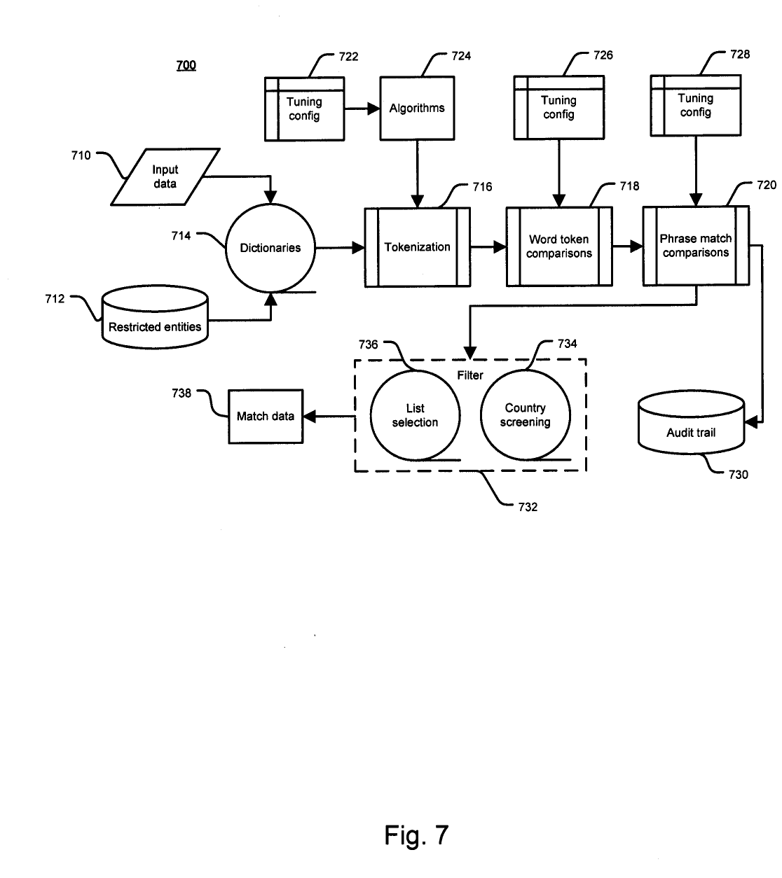

FIG. 7 depicts the process flow of a screening engine according to one embodiment of the present invention. Newly entered partner data 710 and stored data of restricted entities 712 may initially pass through dictionaries 714. Here, the dictionaries 714 may parse out the data that is entered and/or stored into text that may be interpreted by the engine. The dictionaries may comprise a distinct word dictionary, a common words dictionary, a synonym dictionary, an unusual words dictionary, a word fragment dictionary, a character mapping dictionary, or a combination thereof. Other types of dictionaries may also be provided. Tokenization 716, word token comparisons 718, and phrase match comparisons 720 may provide the next level of screening.

Tokenization 716 may comprise indexing the components of partner and stored data by breaking a phrase into one or more words as governed by a set of rules. In one embodiment, there may be a set of different governing rules for tokenizing Names, Addresses, Phone and Fax numbers, Postal Codes, etc. The set of rules for Name and Address may be the most complex as these two phrase types are the most commonly utilized for restricted party matching. In another embodiment, several codes may be computed from each tokenized word. Here, the screening engine may index each code and may reference the set of words that can compute the code in word token comparisons 718. Each word, in turn, may then reference a set of phrases that contain the words in phrase match comparisons 720, and finally, each phrase may reference the restricted part entity in which it occurs 732. Thus, index tuning involves the types of codes the engine computes from each word and the length of these codes. Increasing the different types of codes and/or reducing the length of the codes may raise the possibility that two distinct words share at least one common code. During tokenization 716, the various codes may be computed from each tokenized word and all the codes of each tokenized query word in the appropriate phrase type index may be located, e.g., the codes computed from words in the Name phrase are searched for in the Name index. When two words have at least one code in common, the engine may further analyze the words to determine whether they are sufficiently “close” to consider as a match.

These codes may be computed by a number of various algorithms 724 and may comprise alphabetic n-grams, consonant n-grams, numeric n-grams, soundex, phonex, metaphone, and/or any combination thereof. Additional algorithms for computing codes may also be considered. For n-gram-type algorithms, an n-gram is a code of length n that produces (m−n+1) codes (not necessarily distinct) for a word of length m. For example, the word “dictionary” may yield the following set of 3-grams: dic, ict, cti, tio, ion, ona, nar, ary. In one embodiment, alphabetic n-grams may provide a set of n-grams in a word that remain after all non-alphabetic characters have been removed. For example, the set of n-grams for the words “pier” and “pier99” may be considered the same. In another embodiment, consonant n-grams may provide a set of n-grams in a word after all non-alphabetic characters and vowels have been removed. For example, the word “dictionary” may yield the following set of consonant 3-grams: dct, ctn, tnr, nry. In another embodiment, numeric n-grams may provide a set of n-grams in a word after all non-numeric characters have been removed. This may be useful in indexing Addresses, Phone and Fax numbers, and Postal Codes. In one embodiment, soundex may be used to group together words of same and similar sounds, but with variant spellings. A short soundex code may increase the probability that two words result in the same soundex code. In another embodiment, phonex and metaphone may be used. Like soundex, phonex and metaphone codes may be computed based on phonetic sounds. While these are particularly useful for the English language, other phonetic algorithms may utilized for non-English languages, such as Arabic, Chinese, Spanish, etc. Each of the algorithms 724 used may also be tuned according to the tuning configuration 722.

Once the engine 700 computes the set of potentially matching words for a given query word, word token comparisons 718 may compare each word in the set with the query word to determine the similarity between the two words. The tuning configuration 726 for word token comparisons 718 may enable the determination of how the word similarity is calculated and the level of similarity between words is identified.

In one embodiment, an algorithm, such as edit distance, may be used to calculate word similarity. An edit distance of two words may be computed by summing the number of inserts, deletes, substitutions, and swaps to be performed on one of the two words to yield the other. If the computed edit distance is equal to or below a configured threshold, the two words may be considered a match. The threshold may be tuned according to the tuning configuration 726. In another embodiment, an alternative to edit distance may be used. Here, the algorithm may consider matching two words based on a phonetic approach, for example, by matching their soundex, phonex, or metaphone codes. While tuning may be more difficult to achieve in this example, the length of these codes and how it affects the probability of two words sharing the same code value may be tuned.

There may be a number of various tuning configurations 726 for word token comparisons 718. In one embodiment, a swap may be assigned a lesser “cost” than an insert-delete-substitution. For example, a swap may be assigned a cost of 0.6 and an insert-delete-substitution may be assigned a cost of 1.0. Here, the higher the cost, the more likely the two words being compared may be considered a match. Under this scenario, a word such as “clever” and “clevre” (an insert-delete-substitution) may be considered more similar than “clever” and “clover” (a swap). In another embodiment, words may be considered a match if the edit distance is below a given threshold, based on the assigned cost as described above. This threshold may be configured to be static or dynamic. For a static configuration, a maximum edit distance may be specified between two words and still be considered a match. In a dynamic configuration, the engine may compute the edit distance based on the length of the shorter of the two words. Here, the threshold may be higher for words that are longer.

In yet another embodiment, a prefix-difference penalty may be assessed on a calculated edit distance. For example, the words “river” and “diver” may normally have an edit distance of one. But because of their difference based on the prefixed first letter, a prefix-difference penalty of two may be assessed to yield a final edit distance of three instead of one. Here, the flexibility of configuring penalties may improve the likelihood of securing more accurate word matches. For example, a prefix-difference penalty may not be assessed for words have a phonetically similar sound, such as “phone” and “fone.” Here, it may be more reasonable to not assess any prefix-difference penalty since the word prefix are phonetically equal.

In another embodiment, sub-string matching may be provided to match restricted entities contained within longer text strings such as when the first and last names of partners may be conjoined. For example, without sub-string matching, the engine may not be able to flag the entity “SaddamHussein” as a single string because the engine compares the single string “SaddamHussein” to the two words: “Saddam” and “Hussein”. The edit distance to attempt and match a 13-letter word to two words—one with six letters and the other with seven—may be too great to result in a match. Thus, by using sub-string matching, the engine may better break down words of more than four letters (a setting that may also be adjusted and tuned) and attempts to locate matches on sub-strings within individual words. Using sub-string setting in the example discussed above, “SaddamHussein” may have a strong match with “Saddam Hussein.” While sub-string matching may increase the number of false positives, the average increase is trivial when compared to the screening benefits and advantages.

Phrase match comparisons 720 may also be provided in the screening process. Once the engine compiles the set of words matching in a given query phrase, the system further analyzes every phrase of the same type containing one or more of these words to determine if the two phrases constitutes a match. This may be accomplished by computing the phrase similarity value and determining if this value is greater than or equal to the configured threshold. The tuning configuration 728 for phrase match comparisons 720 may include word match weight, phrase similarity computations, and minimum phrase similarity value. In one embodiment, a word match weight may be assigned to each matching word based on the strength of the match. There may be several match levels: exact match, strong-approximate match, and weak-approximate match. These weighted awards may be configured and tuned for each of these levels. An exact match may have a higher award weight than for a strong-approximate match. Similarly, a strong-approximate match may have a higher award weight than for a weak-approximate match. For example, a weight of 1.0, 0.8, and 0.6 may be given for an exact, strong-approximate, and weak-approximate match, respectively. In another embodiment, phrase similarity computations may be used to calculate the phrase similarity value between two phrases. For example, two phrases may be computed for phrase similarity:

“MangSha Clothing Outlet” and “MingShi Factory”. Here, the words “MingShi” and “MangSha” are spelled differently so that a strong-approximate weight may be awarded for this word match. A weight of 0.8 may be configured for this strong-approximate match.

Phrase similarity computations may be comprised of several types. In one embodiment, common-words-to-unique-words computation may be used to calculate phrase similarity. Here, a simple method is used to calculate phrase similarity by taking the sum of the common word eights and dividing by the number of unique words in the two phrases. The phrase similarity value the sample phrases discussed above is 0.8, divided by 4, the number of unique words in the two phrases (“MangSha” and “MingShi” are considered the same word because a strong-approximate match was made). Thus, a phrase similarity value of 0.8/4=0.2 may be achieved.

In another embodiment, a common-words-to-minimum-phrase-length may be used by taking the sum of the common word weights and dividing by the number of words in the small of the two phrases. Here a word difference penalty may also be applied. The penalty may be adjusted by tuning the word-difference-penalty weight. For example, the penalty may be set from 0.0 to 0.4. A higher value may result in a steeper penalty while a value of 0.0 has the effect of no assessed penalty. Assuming Ln represents the number words in the larger phrase, Sn the number of words in the smaller phrase, and P as the word-difference penalty weight, then a possible word-difference-penalty computation, if a value of 0.1 has been configured as the word-different-penalty weight, may appear as:

(Ln/Sn)−1)×P=(( 3/2)−1)×0.1=0.5×0.1=0.5

A weight of 0.2 would yield a penalty of 0.1. Thus, in this embodiment, a phrase similarity value for the sample phrase using the common-words-to-minimum-phrase-length computation may be (0.8/2)−0.05=0.35.

In another embodiment, a common-words-to-query-phrase-length computation may be utilized. Here, the engine may calculate the common-words-to-query-phrase-length by taking the sum of the common word weight and dividing by the number of words in the query phrase. As with the common-words-to-minimum-phrase-length embodiment, the engine may subtract a word difference penalty from the computed phrase similarity value. Thus, a phrase similarity value for the above example using this computation may yield (0.8/3)−0.05=0.2167.

In addition to phrase similarity computations, a match score may also be provided for assessing the relative strength of a match. Here, a minimum phrase similarity value may be calculated. In one embodiment, a lower-bound threshold may be configured such that if the phrase similarity value is greater than or equal to this threshold, the phrase may be considered to match. Furthermore, the overall match score having the highest phrase similarity value may be the value used to compute the phrase match. For example, if a partner is matched, the system may break the partner into its phrases (i.e., Name, Address, etc.) and may attempt to match each of these phrase types against the appropriate indexed phrases. So, a Name of “Sadam Smith” having matches to two Names phrases with a score of 0.73 and 0.65 and an Address “433 North Street” having a match to one phrase with a score of 0.68 may ultimately have an overall match score of 0.73 (the highest) assigned to the partner. Although the match score is not an absolute value or definitive indicator of a potential match, it may be helpful in comparing the strength of different matches to the same screened partner.

### Tuning, Audit Trails and List Consolidation

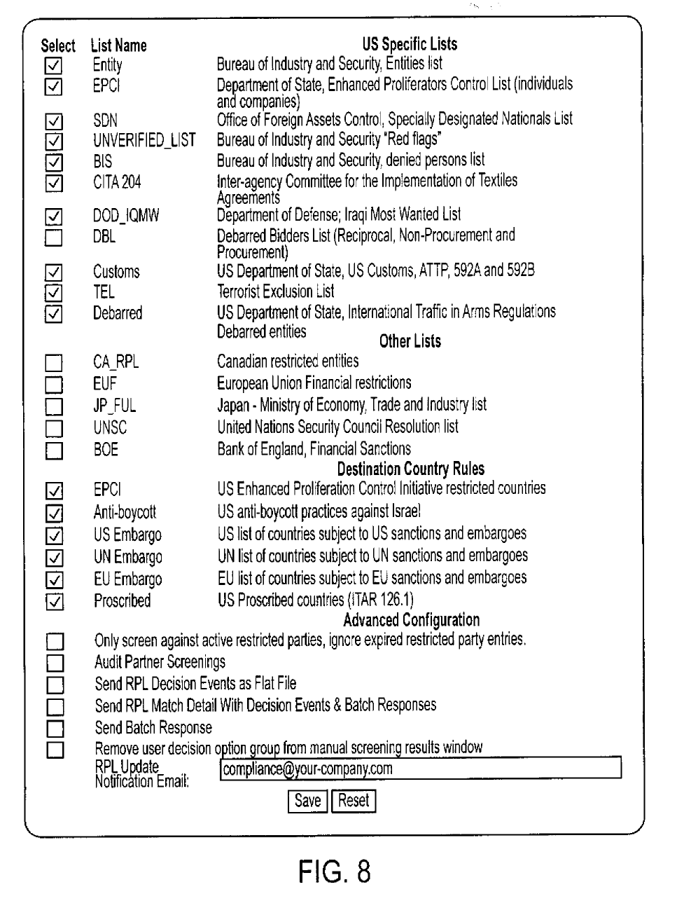

Once tokenization 716, word token comparisons 718, and phrase match comparisons 720 have processed the partner data, the data may then be stored in audit trail database 730 and filtered by a filter 732 comprising a list selection 736 and country screening 734. Here, the user may configure and identify the US-specific lists, other lists, destination control Rules, and advanced configuration options that control screening. The list consolidation and management feature comprises consolidating more than forty lists from governments, organizations, and other entities around the world into one central database that may be monitored and updated daily. As a result, the present invention may provide up-to-date, real-time screening. Some possible List Names that display on a configuration page for a user is depicted in FIG. 8 and may comprise: customs, SDN, and entity lists. Custom lists may include at least three separate customs lists, such as Customs ATTP, Customs 592A, and Customs 529B. SDN may comprise at least twenty-four separate lists published by the OS Office of Foreign Assets Control. Entity lists may consist of at least three separate list US Bureau of Industry and Security lists, such as Entity, Entuty CCL, and Entity CCL+999. In addition, there may also be at least six country Rules—the Destination Country Rules—that may apply and be configured for screening. These may include at least: Enhanced Proliferation Control Initiative (EPCI), Israeli boycott, US-embargoed Countries, US-proscribed Country List, EU-embargoed Countries, EU-embargoed Countries, UN-Embargoed Countries. Each Rule may have different consequences depending on the several factors and requirements of the rule.

In a hosted solution application, a user with authorization, such as an Administrator, may access the various tuning parameters that control how the engine performs restricted party screening. Tuning the parameters may provide a user a level of flexibility and control to optimize the screening process. In an operational solution, the tuning may be adjusted by the host Administrator to achieve a highly accurate hit rate on restricted entities while minimizing false positives.

As discussed above, several important aspects of tuning the engine to determine the overall hit ratio and false positive rate may include: (1) indexing, (2) word matching, and (3) phrase matching. Various types of dictionaries may also provide additional help in configuring and tuning a screening engine. In addition, there may also be several ways to change tuning parameters. In one embodiment, this may include modifying the configurations files, e.g., DenperConfigUI.cfg or DenperUI.cfg, and through tuning windows. Here, a user may adjust the tuning options by moving sliders for each of the tuning options, selecting check boxes, or by specifying actual values. In another embodiment, a test screening window may also allow a user to adjust tuning parameters by testing screening executions.

### Reporting

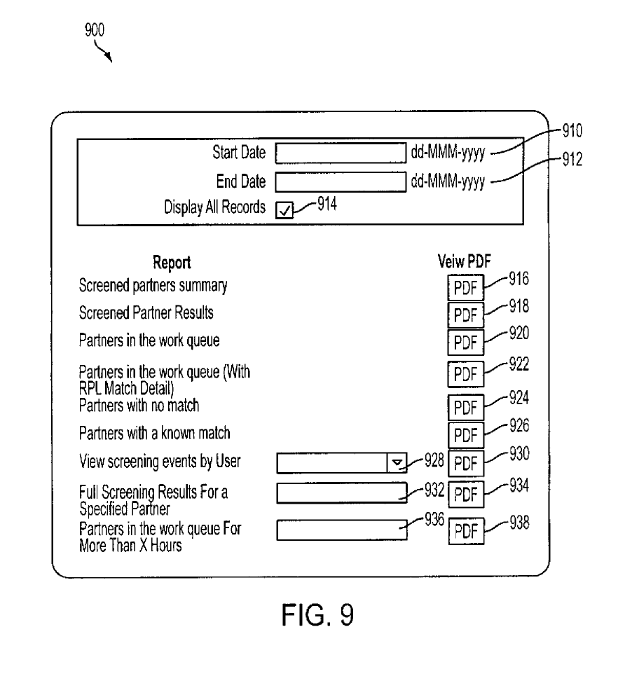

Match data 738 of FIG. 7 may be accessed through a reporting feature of the present invention. FIG. 9 depicts a screenshot for a restricted party screening reports page. Here, reports may be generated to provide a variety of information about partners that have been screened. This information includes at least those depicted in FIG. 9—date 910 and 912, screened partners summary 916 and results 918, partners in work queue 920 and 922 (awaiting a user's decision), partners at the various levels of “match” 924 and 926, specified users 928, full screening results for a specified partner 932, partners in the work queue for a specified amount of time 936, etc. Reports may be accessed by a user in the hosted solution embodiment, and by the assistance of a host agent in an operational embodiment. Reports may also be available in a variety of formats, such as PDF and spreadsheet formats, e.g., Microsoft Excel. These amount of information and the reporting formats may be configured by the user within the specific elected embodiment by the user. Flexibility in customizing the reporting features to specific business needs is one advantage provided by the reporting feature. Another advantage is that quite often, large reports may prove difficult to manage. Therefore, have customizable options in the amount of information, the format of delivery/viewing, etc., a user may optimize screening performance and decrease the amount of time necessary to perform the screening.

The advanced reporting feature comprises a central database where all search results may be stored. Such results may include dates and actions taken by the user or host or both. These may comprise match data, decisions made, and decisions made by which user. In addition, all other information discussed above resulting from the screening may also be stored in the database for review or future retrieval. By integrating database functionality, this reporting feature may provide detailed compliance screening reports which may be essential to upholding government audits.

### Resolution Services

As discussed above, in an operational solution, a resolution services feature may be provided. In one embodiment, a host agent may monitor user work queues, resolve matches through an ISO compliant process to review the potential match, and determine whether a match is a valid match, no match, or an indeterminate potential match that requires further review. A senior analyst or user may provide final verification at this stage. In another embodiment, a host agent professional may assist in conducting additional research to determining whether a suspected match is valid. The compliance decision (valid, match, indeterminate, false positive, or no-match) may be reported to the user by the host, where the user decides on how to proceed. In another embodiment, a host agent specialist may also provide dedicated and personal response services for a user to perform accurate analysis of matches based on case-specific situations.

The advantages of resolution services is that it eliminates the need for a user to have trained in house professionals to resolves matches. This may reduce a significant amount of time and expenses related to screening. In addition, a well-trained team of specialists provides a greater level of reliability and credibility to restricted part screening.

### OTHER EMBODIMENTS

Accordingly, other embodiments of the present invention also be considered. For example, one embodiment may include “white-listing.” Here, not only are valid and potential matches stored and reported to a user, non-matches may be stored and reported in an advanced feature within “white-listing” to provide information on partners, entities, and countries that may not be of any potential risk. This may provide a user access to view entities, companies, and countries in good standing.

Another embodiment may also comprise a translation services. This may be particularly useful in the screening engine system and method for screening different non-English languages. Translation services may be integrated into the screening engine system and method to provide searchability for non-Romanized languages, such as Chinese and Arabic. In one embodiment, a third party may provide translations. In another embodiment, translation may be provided automatically by a machine. A translation services may convert input data, stored restricted entities, list data, user databases, audit trails, and country lists. It may also be useful in re-configuring or providing algorithms for parsing, tokenizing, and screening the data in the engine. Various other examples for translations services may also be considered.

Another embodiment of the present invention may also comprise a multi-tiered, hierarchical structure of restricted party screening. This may be useful in a large, global corporation, for example, comprising many sub-divisions. In one embodiment, the results of performing on screening for one sub-division may be used or incorporated by another sub-division within the entire corporation or by the corporation itself. In another embodiment, a user with authorization to make decisions for several sub-division may verify a match for several sub-divisions at the same time, in one decision, or in multiple languages. Adding a hierarchal structure provides saves time and prevents double-screening. Ultimately, it provides greater flexibility, efficiency, consistency, and a more global approach to restricted party screening.

According to an embodiment of the invention, the systems and processes described in the above invention may be implemented on any general or special purpose computational device, either as a standalone application or applications, or even across several general or special purpose computational devices connected over a network and as a group operating in a client-server mode. According to another embodiment of the invention, a computer-usable and writeable medium having a plurality of computer readable program code stored therein may be provided for practicing the process of the present invention. The process and system of the embodiments of the present inventions may be implemented within a variety of operating systems, such as a Windows® operating system, various versions of a Unix-based operating system (e.g., a Hewlett Packard, a Red Hat, or a Linux version of a Unix-based operating system), or various versions of an AS/400-based operating system. For example, the computer-usable and writeable medium may be comprised of a CD ROM, a floppy disk, a hard disk, or any other computer-usable medium. One or more of the components of the system or systems embodying the embodiments of the present inventions may comprise computer readable program code in the form of functional instructions stored in the computer-usable medium such that when the computer-usable medium is installed on the system or systems, those components cause the system to perform the functions described. The computer readable program code for the embodiments of the present inventions may also be bundled with other computer readable program software. Also, only some of the components may be provided in computer-readable code.

Additionally, various entities and combinations of entities may employ a computer to implement the components performing the above-described functions. According to an embodiment of the invention, the computer may be a standard computer comprising an input device, an output device, a processor device, and a data storage device. According to other embodiments of the invention, various components may be computers in different departments within the same corporation or entity. Other computer configurations may also be used. According to another embodiment of the invention, various components may be separate entities such as corporations or limited liability companies. Other embodiments, in compliance with applicable laws and regulations, may also be used.

According to one specific embodiment of the present invention, the system may comprise components of a software system. The system may operate on a network and may be connected to other systems sharing a common database. Other hardware arrangements may also be provided.

The present disclosure is not to be limited in scope by the specific embodiments described herein. Indeed, other various embodiments of, uses of, and modifications to the present disclosure, in addition to those described herein, will be apparent to those of ordinary skill in the art from the foregoing description and accompanying Exhibits. Thus, such other embodiments, uses, and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

1. A system for screening data for restricted party screening comprising:
an input for entering data;
a screening system for screening the data against a database comprising restricted entities information, generating a match score based on the screening of the data, providing a data match based on the match score, and outputting the data match;
a work queue for reviewing the data match; and
a report generated based on the review of the data match.

2. The system of claim 1 wherein the input comprises an interface for manual entry of data.

3. The system of claim 1 wherein the input comprises an interface for flat-file data input.

4. The system of claim 3 wherein the flat-file data is inputted by secure FTP.

5. The system of claim 1 wherein the input comprises an interface for XML data input.

6. The system of claim 1 wherein the restricted entities comprises information from at least one of commercial entities information, partners or customers information, government information, information from embargoes, or information based on a combination thereof.

7. The system of claim 1 wherein the screening system comprises a database.

8. The system of claim 7 wherein the database comprises at least one of a restricted entities database, customer or partner database, and an audit trail database.

9. The system of claim 1 wherein the screening system further comprises a screening engine comprising at least one dictionary.

10. The system of claim 9 wherein the screening engine further comprises a component for tokenization, a component for word token comparisons, and component for phrase match comparisons.

11. The system of claim 10 wherein each of the components for tokenization, for word token comparisons, and for phrase match comparisons further comprises a tuning configuration.

12. The system of claim 11 wherein the tuning configuration for the tokenization component further comprises at least one algorithm.

13. The system of claim 12 wherein the at least one algorithm is at least an alphabetic n-gram, consonant n-gram, numeric n-gram, soundex, phonex, metaphone, or any combination thereof.

14. The system of claim 9 wherein the screening system is configured to screen data in English.

15. The system of claim 14 wherein the screening system further comprises a translation component for translating non-English language into English for screening data.

16. The system of claim 15 wherein the translation component is provided by a machine.

17. The system of claim 15 wherein the translation component is provided by a third party.

18. The system of claim 9 wherein the screening system is configured to screen data in a non-English language.

19. The system of claim 1 wherein the data match based on a match score yields at least one of a match, potential match, or no match.

20. The system of claim 1 wherein the match score and data match are stored in a database.

21. The system of claim 1 wherein the report is accessible through at least one of a user interface.

22. The system of claim 21 wherein the report is viewed in a PDF format.

23. The system of claim 21 wherein the report is viewed in a spreadsheet format.

24. The system of claim 1 further comprising a match verification component for reviewing the report and generating a match verification decision.

25. The system of claim 24 wherein the match verification decision is provided by a user.

26. The system of claim 24 wherein the match verification decision is provided by a host agent.

27. The system of claim 24 wherein the match verification decision is used for identifying a restricted party or black-listing.

28. The system of claim 24 wherein the match verification decision is used for identifying a non-restricted party or white-listing.

29. The system of claim 24 wherein the match verification decision is stored in a database.

30. The system of claim 1 wherein the system is in a computer-executable format.

31. The system of claim 1 wherein the system is accessed through a network.

32. The system of claim 35 wherein the system is accessed through a web user interface.

33. The system of claim 1 wherein the system has a hierarchical structure for a multi-level application.

34. A method for screening data for restricted party screening comprising:
inputting data;
screening the data against a database comprising restricted entities information;
generating a match score based on the screening of the data;
providing a data match based on the match score;
outputting the data match;
reviewing the data match in a work queue; and
generating a report based on the review of the data match.

35. A system for screening data comprising:
an input for entering data;
a screening system for screening the data against a database comprising restricted entities information, generating a match score based on the screening of the data, providing a data match based on the match score, and outputting the data match;
a match verification component for reviewing the data match and generating a match verification decision, wherein the match verification component is provided by a host agent and the match verification decision is based on the data match; and
a report generated based on the match verification decision.

36. A method for screening data comprising:
inputting data;
screening the data against a database comprising restricted entities information;
generating a match score based on the screening of the data;
providing a data match based on the match score;
outputting the data match;
reviewing the data match by a match verification component to generate a match verification decision, wherein the match verification component is provided by a host agent and the match verification decision is based on the data match; and
generating a report based on the match verification decision.

37. A method for screening data comprising:
inputting data;
screening the data against a database comprising restricted entities information;
generating a match score based on the screening of the data;
providing a data match based on the match score;
outputting the data match;
reviewing the data match by a match verification component to generate a match verification decision, wherein the match verification component is provided by a user and the match verification decision is based on the data match; and
generating a report based on the match verification decision.
